(19) United States
(12) Patent Application Publication
(10) Pub. No.: US 2011/0309563 A1
(43) Pub. Date: Dec. 22, 2011

(54) POST FINISHING DEVICE AND IMAGE FORMING SYSTEM USING THE SAME

(75) Inventor: Takanori TOGAWA, Tokyo (JP)

(73) Assignee: KONICA MINOLTA BUSINESS TECHNOLOGIES, INC., Tokyo (JP)

(21) Appl. No.: 13/159,607

(22) Filed: Jun. 14, 2011

(30) Foreign Application Priority Data
Jun. 22, 2010 (JP) JP2010-141301

(51) Int. Cl. B41F 13/64; B41L 43/10

(52) U.S. Cl. 270/58.11

(57) ABSTRACT

A post finishing device for attaching a binder into punched holes of bundled sheets to bind the bundled sheets, and producing a booklet bound with the binder, including: a stacking section for stacking the booklet produced; and a position adjusting section for adjusting a stacking position of the booklet on the stacking section, in such a way that when the booklet is stacked on the stacking section, the binder to bound the booklet does not come into contact with a binder of another booklet having been stacked on the stacking section.

### CROSS REFERENCE TO RELATED APPLICATION

This application is based on Japanese Patent Application No. 2010-141301 filed on Jun. 22, 2010 with the Japanese Patent Office, the entire content of which is hereby incorporated by reference.

### TECHNICAL FIELD

The present invention relates to a post finishing device and an image forming system using the same device.

### BACKGROUND ART

As post finishing devices to be combined with image forming apparatuses, such as copying machines and printers, recently prevailed are devices including an electric stapler which binds a set of recording sheets, fed out continuously from the image forming apparatus, and forms booklets one by one.

Further, as post finishing devices to form booklets, punched holes are formed on the recording sheets, and ringed binding members are inserted into the punched holes, whereby a booklet bound with a binder is produced (see booklet BK shown in FIG. 4). Various technologies, concerning such post finishing devices, have been offered in recent years. For example, according to technologies disclosed in Unexamined Japanese Patent Application Publication 2008-94081, cartridges, accommodating various sizes of binders, are loaded, whereby a binder, fitting the thickness of bundled sheets, is selected for binding the booklet, so that a booklet, bound by a suitable binder, is produced.

Since the booklet bound by the binder is handsome and impressive, and since the user can easily turn over the pages of said booklet, said booklets have gained acceptance as a form of the booklet which is automatically produced by the post finishing device.

However, the booklet, bound by the binder, is ejected onto a tray, and said booklet carries the binder on its side, whereby when several booklets are stacked on the tray, their covering binders may adversely come into contact with each other.

If the binders of the booklets come into contact with each other, the total height of the stacked booklets will increase due to the binders, which come into contact with each other. Accordingly, even though a relatively small number of booklets are stacked on the tray, the total height of the stacked booklets quickly reaches a maximum stacking limit for the tray, which makes it impossible to stack large number of booklets on the tray. In case that the plural booklets, each bound with the binder, are to be produced by a single job operation, the job operation must be divided into plural operations, due to a possible stacking amount on the tray, which results in reduction of speed for producing the plural amounts of booklets.

Further, if the binders of the booklets come into contact with each other on the tray, the booklets tend to be stacked in a confused order, whereby the stacked booklets look unsightly, still further, the user cannot take out the stacked booklets easily.

### SUMMARY OF THE INVENTION

A post finishing device for attaching a binder into punched holes of the bundled sheets to bind the bundled sheets, and producing a booklet bound with the binder, reflecting one aspect of the present invention, comprises: a stacking section which stacks the booklet produced; and a position adjusting section which adjusts a stacking position of the booklet, in such a way that when the booklet is to be stacked on the stacking section, a binder, attached into the punched holes of the booklet, does not come into contact with a binder of another booklet, which has already been stacked on the stacking section.

Further, an image forming system relating to the present invention comprises: an image forming apparatus which forms an image on a recording sheet; and a post finishing device which uses the recording sheets on which the image has been formed by the image forming apparatus, and produces a booklet which has been bound with a binder.

### BRIEF DESCRIPTIONS OF THE DRAWINGS

The embodiments will now be described, by way of example only, with reference to the accompanying drawings which are meant to be exemplary, not limiting, and wherein like elements are numbered alike in the several figures, in which:

FIG. 1 shows a schematic structure of an image forming system relating to the present invention;

FIG. 2 is a block diagram to show a controlling system of the image forming system;

FIG. 3 is a central cross-sectional view of a binding device;

FIG. 4 is a perspective view of one example of a booklet which is bound with a binder by a binding section;

Each of FIGS. 5a and 5b shows a side view of the binder;

FIG. 6 is a flow chart to show operations for adjusting the stacked positions of the booklets;

Each of FIGS. 7a and 7b shows a partial top view of the booklet, which is bound with the binder;

FIG. 8 is a side view of a stacking section, in which the stacked positions of the booklets have been adjusted;

FIG. 9 is a side view of the stacking section, in which the stacked positions of the booklets have been adjusted;

FIG. 10 is a side view of the stacking section, in which the stacked positions of the booklets have been adjusted;

FIG. 11 is a side view of the stacking section, in which the stacked positions of the booklets have been adjusted;

FIG. 12 is a side view of the stacking section, in which the stacked positions of the booklets have been adjusted;

FIG. 13 is a side view of the stacking section, in which the stacked positions of the booklets have been adjusted; and

FIG. 14 is a side view of the stacking section, in which the stacked positions of the booklets have been adjusted.

### DETAILED DESCRIPTIONS OF THE PREFERRED EMBODIMENTS

### A Brief of the Image Forming System

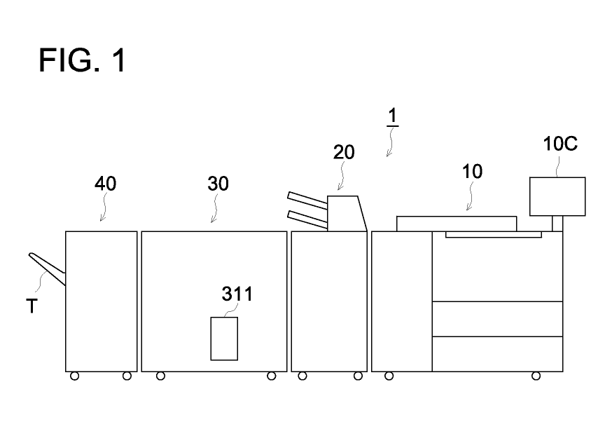

FIG. 1 shows a schematic structure of the image forming system, relating to the present invention.

The image forming system shown in FIG. 1 is structured of image forming apparatus 10, sheet inserting device 20, sheet binding device 30 (being a post finishing device), and sheet stapling device 40.

Image forming apparatus 10 is a digital compound apparatus, wherein various jobs, to be conducted by image forming system 1, can be set through operation display section 10C, which is mounted on the top portion of image forming apparatus 10. Further, image forming apparatus 10 is connected to a network, to conduct the jobs received through the network

Image forming apparatus 10, having a plurality of sheet supplying trays, forms an image on a recording sheet, accommodated in said sheet supplying trays, and conveys the recording sheet to sheet inserting device 20, and sheet binding device 30, both of which are installed in downstream of image forming apparatus 10, in the sheet conveying direction.

Sheet inserting device 20, connected with image forming apparatus 10, has a plurality of sheet supplying trays, so that a recording sheet, carrying a formed image, or a recording sheet, which cannot be introduced in image forming apparatus 10, can be placed on a top or an end of the recording sheets, conveyed from image forming apparatus 10, or can be inserted between the recording sheets, conveyed from image forming apparatus 10.

After sheet binding device 30 receives recording sheets, which have been conveyed from image forming apparatus 10 or sheet inserting device 20, sheet binding device 30 conducts a binding process, in which a booklet bound with a binder is produced, or sheet binding device 30 conveys the recording sheets to sheet stapling device 40, without conducting the binding process. Sheet binding device 30 will be detailed later, but in case that sheet binding device 30 conducts the binding process, after punched holes are produced on the recording sheet, said recording sheets are sequentially stacked on a single position, to be a bundle of recording sheets. Binder rings are subsequently applied into the punched holes of the bundle of recording sheets, so that a booklet bound with the binder is produced. The booklet bound with the binder, is stacked on stacking section 311. The operator opens the front cover of binding device 30, and takes out the produced booklets, stacked on stacking section 311.

Stapling device 40 is installed at the most downstream position, in the sheet conveying direction, of image forming system 1. Stapling device 40 is configured to temporarily stack a plurality of recording sheets, conveyed from image forming apparatus 10, as a bundle of recording sheets. Stapling device 40 applies staples into the bundle of recording sheets to produce a booklet. The booklet, having been stapled, is ejected onto ejection tray T. In addition, recording sheets, which were not stapled by stapling device 40, are also ejected onto ejection tray T.

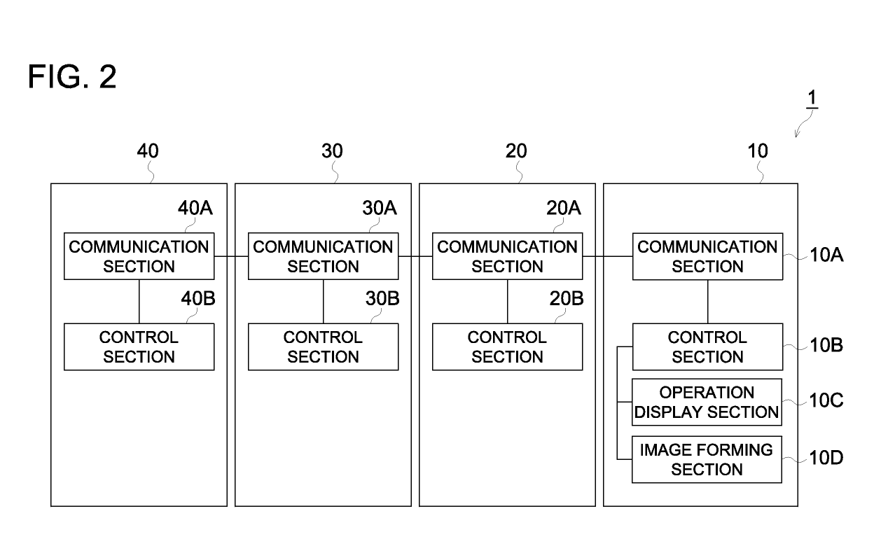

FIG. 2 is a block diagram to show a controlling system of image forming system 1, which shows a typical structure of the present invention.

Image forming apparatus 10, sheet inserting device 20, sheet binding device 30, and sheet stapling device 40 are electrically connected with each other through communication sections 10A, 20A, 30A, and 40A, so that various control signals are communicated. Control sections 10B, 20B, 30B, and 40B together control the operations of image forming system 1. In more detail, control section 10B controls each section of image forming apparatus 10. Control sections 20B, 30B, and 40B respectively control sheet inserting device 20, sheet binding device 30, and sheet stapling device 40.

Control sections 10B, 20B, 30B, and 40B are structured of CPU (Central Processing Unit), ROM (Read Only Memory) and RAM (Random Access Memory). and read out various control programs stored in ROM.

Operation display section 10C is configured to display various information, and to make various settings to become active. Operation display section 10C is, for example, formed to be a touch panel, through which the operator inputs various commands to image forming system 1, whereby contents of a job to be conducted by image forming system 1 can be determined.

Image forming section 10D is configured to form an image on a recording sheet. In more detail, an electro-photographic process is conducted by a photosensitive body, an electrical charging section, an exposure section, a developing section, a transfer section, and a fixing section, so that a toner image is formed on the recording sheet

### [A Brief of the Binding Device]

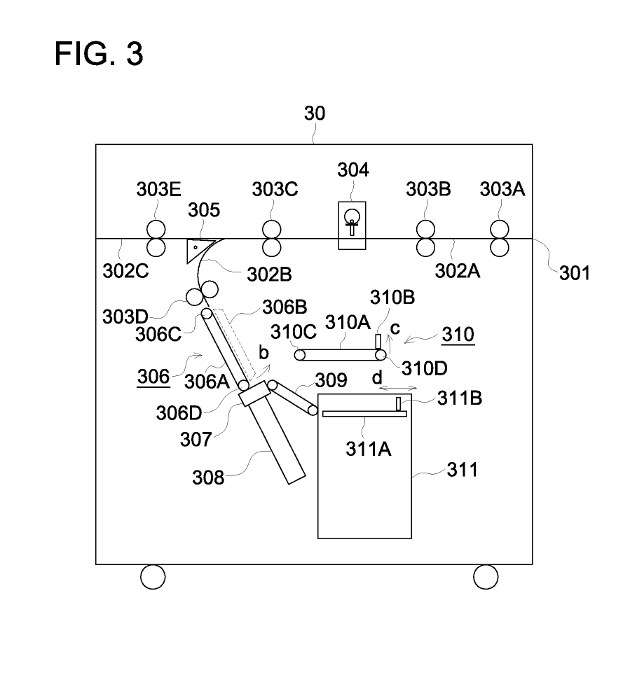

Detailed structures of binding device 30 will now be detailed, while referring to FIG. 3, which is a central cross-sectional view of binding device 30.

As detailed above, in sheet binding device 30, which is installed between sheet inserting device 20, and sheet stapling device 40, a binder is applied into the punched holes of the bundle of recording sheets, so that a booklet bound with a binder can be produced.

A recording sheet is controlled to enter binding device 30 through sheet entrance 301, and is conveyed through conveying route 302A, by paired conveying rollers 303A, 303B, and 303C.

Hole punching section 304, which is configured to punch holes into the recording sheet, is mounted downstream of conveying roller 303B, with respect to the sheet conveying direction. In case that sheet binding device 30 is to produce a booklet bound with a binder, after the recording sheet is controlled to stop at a predetermined position by conveying roller 303B, a plurality of holes are punched at a leading side of the recording sheet (at the leading side in the sheet conveying direction) by hole punching section 304. Conveying roller 303B is driven by a stepping motor, which is not illustrated. Control section 30B (see FIG. 2) of sheet binding device 30 controls the number of steps applied to the stepping motor, so that the recording sheet can be stopped at the predetermined position.

Conveying route switching plate 305 is mounted downstream of conveying roller 303C, with respect to the sheet conveying direction. In case that sheet binding device 30 is to produce a booklet bound with a binder, the recording sheet is conveyed to conveying route 302B by conveying route switching plate 305. In case that sheet binding device 30 is not to produce a booklet bound with a binder, the recording sheet is conveyed to conveying route 302C by conveying route switching plate 305.

To produce the booklet bound with the binder, the recording sheet, conveyed through conveying route 302B, is temporarily stacked on sheet stacking section 306. Sheet stacking section 306 is basically structured of conveying belt 306A, aligning plate 306B, and supporting rollers 306C and 306D. The recording sheets are conveyed to sheet stacking section 306, and stacked on sheet stacking section 306, so that the punched holes, formed by hole punching section 304, are directed downward.

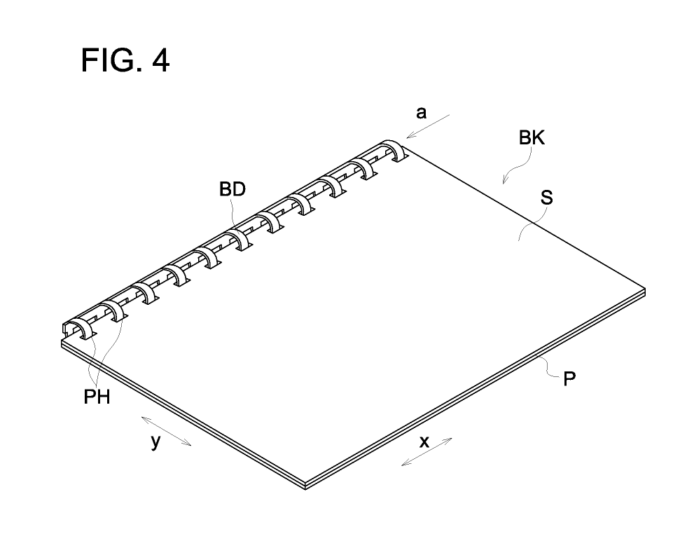

Binding section 307 is mounted under sheet stacking section 306, and binder cartridge 308 is mounted under binding section 307. After a predetermined number of recording sheets, to be formed as a booklet, are stacked on sheet stacking section 306, said stacked recording sheets are aligned in the sheet width direction by aligning plate 306B, to be a bundle of recording sheets. Subsequently, binder BD is attached into the punched holes PH of the bundle of recording sheets, so that booklet BK bound by binder BD is produced (see FIG. 4).

The binders to be used by binding section 307 are accommodated in binder cartridge 308, whereby when the binding process is conducted, binder section 307 receives a binder for each binding process, from binder cartridge 308. A plurality of types of binders have been accommodated in binder cartridge 308, so that they can be selected, based on a binding job to conduct the binding process.

FIG. 4 is a perspective view of one example of booklet BK which is bound with a binder by binding section 307.

As shown in FIG. 4, booklet BK, produced by binding section 307, represents a condition that the plurality of recording sheets S are bound with binder BD, which is attached onto a plurality of punched holes PH of the plurality of recording sheets S. Booklet BK, bound with the binder, looks nice, and the user can easily turn the pages.

Each of FIGS. 5a and 5b shows a side view of booklet BK, which is viewed in direction “a” in FIG. 4, whereby two types of binders BD are illustrated.

Binder BD shown in FIG. 5a is ring-shaped, which is formed to be the same as binder BD used for booklet BK shown in FIG. 4. Binder BD shown in FIG. 5b is plate-shaped, being different from binder BD used for booklet BK shown in FIG. 4.

While binder BD shown in FIG. 5b is accommodated in binder cartridge 308, said binder BD is a flat plate member. In case that the binding process is to be conducted by binding section 307, after binder BD has been inserted into punched holes PH, binder BD is folded so that binder BD results in a shape shown in FIG. 5b.

In case that a binding process is to be conducted, while using binder BD shown in FIG. 5b, length X1 of top portion BD1 of binder BD varies, depending upon the number of recording sheets or the thickness of recording sheet, to be used for booklet BK. Accordingly, if binder BD shown in FIG. 5b is used, a single binder BD can bind booklet BK, including a thick booklet as well as a thin booklet. In more detail, ring-shape binder BD, shown in FIG. 5a, is configured to bind not greater than 50 sheets, and to bind 51-100 sheets. Plate-shaped binder BD, shown in FIG. 5b, can bind 5-100 sheets.

Returning to FIG. 3, concerning binding device 30, an operation for stacking a booklet bound with a binder on stacking section 311 will now be detailed.

In case that after the binding process has been conducted by binding section 307, a front and reverse of a booklet is not to be reversed, supporting roller 306D, conveying belt 306A, and aligning plate 306B are together rotated in direction “b”, while being pivoted by supporting roller 306C of stacking section 306. Subsequently, they stop at predetermined positions. After that, conveying belt 306A of stacking section 306 rotates clockwise in FIG. 3, so that said booklet is delivered to relay-conveying belt 309.

In case that after the binding process has been conducted by binding section 307, the front and reverse of the booklet is to be reversed, supporting roller 306D, conveying belt 306A, and aligning plate 306B are together rotated in direction “b”, while being pivoted by supporting roller 306C of stacking section 306. Subsequently, they stop at predetermined positions, which are higher than a delivering position to deliver the booklet to relay-conveying belt 309. After that, conveying belt 306A of stacking section 306 rotates clockwise in FIG. 3, so that said booklet is delivered to reversing section 310. After the booklet has been delivered to reversing section 310, supporting roller 306D still remains at the position where the booklet was delivered to reversing section 310.

After reversing section 310 has received the booklet, conveying belt 310A of reversing section 310 rotates clockwise in FIG. 3, so that the end of the booklet strikes against stopper 310B. After that, supporting roller 306D, conveying belt 306A, and aligning plate 306B are together rotated in direction “c”, while being pivoted by supporting roller 310C, they stop at predetermined positions. Subsequently, conveying belt 310A rotates counterclockwise in FIG. 3, so that conveying belt 310A delivers the booklet to stacking section 306. During this delivering operation, the front and reverse of the booklet is reversed.

After stacking section 306 has received the booklet from reversing section 310, supporting roller 306D, pivoted on supporting roller 306C, rotates in the reverse direction of arrow “b”, and stops. Subsequently, conveying belt 306A rotates clockwise in FIG. 3, so that conveying belt 306A delivers booklet BK to relay-conveying belt 309.

Relay-conveying belt 309, having received booklet BK, rotates at a predetermined timing, so that the booklet strikes against stopper 311B of stacking section 311, and the booklet is then stacked on stacking tray 311A. In case that the booklet is to be stacked on stacking tray 311A, without being reversed, binder BD of booklet BK, shown in FIG. 4, strikes stopper 311B. However, in case that the booklet is to be stacked on stacking tray 311A, after being reversed, side portion P, which is opposite to binder BD of booklet BK, shown in FIG. 4, strikes stopper 311B.

In case that the booklet is to be reversed, as well as in case that it is not reversed, the position of the booklet in the width direction (being perpendicular on the page surface of FIG. 3) is controlled by a controlling member, which is not illustrated, whereby the booklet is conveyed from relay-conveying belt 309 to stacking section 311.

Since stacking tray 311A is vertically movable, after a first booklet has been stacked on stacking tray 311A, stacking tray 311A moves downward as the thickness of said first booklet, subsequently a second booklet is stacked on said first booklet.

Stopper 311B, mounted on stacking tray 311A, is configured to be movable in the horizontal direction, as shown by arrow “d” in FIG. 3. The booklet, to be stacked on stacking tray 311A, is conveyed to strike stopper 311B, and stacked on stacking tray 311A. Accordingly, stopper 311B is controlled to move in the horizontal direction, so that the stacking position of the booklet can be adjusted in the horizontal direction on stacking tray 311A.

### [Adjustment of Stacking Position of Booklet]

The adjustment of the stacking position of the booklet will now be detailed.

In image forming system 1 of the present embodiment, each booklet is moved in the width direction of booklet BK, (which is direction “x” in FIG. 4), or in the direction perpendicular to the width direction (which is direction “y” in FIG. 4), whereby the position of the booklet on stacking section 311 can be adjusted. Direction “x” or direction “y” can be set by each job.

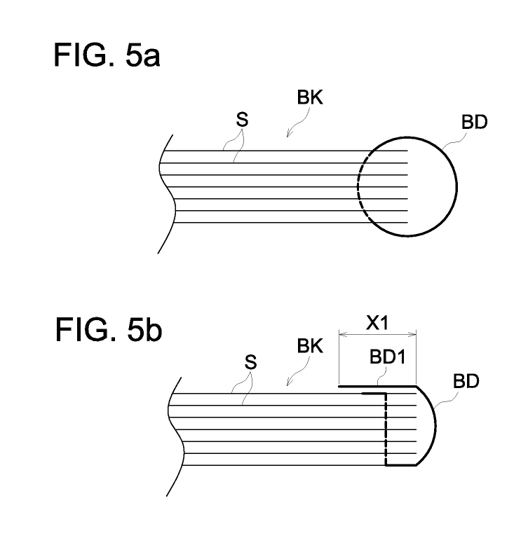

FIG. 6 is a flowchart to show an operation for adjusting the stacking position of the booklet. In the flowchart, control section 30B conducts judging steps (being steps S1, S3, S6, S8 and S11) of FIG. 6, based on predetermined programs, while referring to various information.

In image forming system 1, when a job starts, for producing a booklet bound with a binder, the booklet is moved in the width direction (which is direction “x” in FIG. 4), based on job information, whereby a judging operation is conducted, judging whether the stacking position of the booklet on stacking section 311 is to be adjusted or not (Step S1).

In step S1, in case that the booklet is to be moved in width direction so that the stacking position of the booklet on stacking section 311 is to be adjusted (“Yes” in step S1), the moving distance of aligning plate 306B on stacking section 306 shown in FIG. 3 is calculated (step S2). Aligning plate 306B can conduct the aligning operations of plural recording sheets in the width direction (being the direction perpendicular to the surface of the sheet in FIG. 3) of the booklet, and can move the booklet, on which the binding process has been conducted, in the width direction.

Each of FIGS. 7a and 7b shows a partial top view of the booklet, which has been bound with the binder.

The moving distance, calculated in step S2, is used so that when a booklet, having been bound with a binder, is to be stacked on stacking tray 311A, said binder applied on said booklet does not adversely touch a binder applied on a preceding booklet having been stacked. Said moving distance is calculated, based on width T1 and clearance T2 of binder BD, shown in FIG. 7a. Width T1 and clearance T2 of binder BD, pairing with the types of binder BD to be used, are memorized in binding device 30, which are used in the operation of step S2.

After the moving distance of aligning plate 306B has been calculated in step S2, judging is conducted whether the binding operation of a single booklet in binding section 307 has been completed or not (step S3). If said binding operation has been completed (“Yes” in step S3), aligning plate 306B is moved, based on the moving distance calculated in step S2, so that said single booklet, having been bound with a binder, is moved in the width direction (step S4, being moved along a side surface, to which binder BD has been attached, of the booklet). In addition, step S3 can also be conducted after step S4 has been conducted.

After the booklet has been moved in the width direction, while said booklet is stricken against stopper 311B by the operations of stacking section 306 and relay-conveying belt 309, said booklet is ejected onto stacking tray 311A (step S5). Until the job has been completed, the booklets are moved one after another in the width direction, based on the moving distance calculated in step S2, and ejected onto stacking tray 311A. During the operations in step S2 to step S6, aligning plate 306B represents a position adjusting section of the present invention.

FIG. 7b shows the conditions of booklets BK1 and BK2, stacked on stacking tray 311A by steps S2-S6 of FIG. 6. Booklets BK1 and BK2 on stacking section 311 are viewed from their tops in FIG. 7b. Booklets BK1 and BK2 are stricken against stopper 311B, so that booklet BK2 shown by solid lines is stacked on booklet BK1 shown by dotted lines.

Based on the moving distance calculated in step S2, booklet BK2 was moved in the width direction, whereby binder BD2 of booklet BK2 is shifted from binder BD1 of booklet BK1, so that binders BD1 and BD2 do not interfere with each other. The total height of stacked booklets BK1 and BK2 is effectively controlled, due to the shift between binders BD1 and BD2, whereby a large number of booklets bound with the binders can be stacked on stacking tray 311A. Further, booklets are stacked on stacking tray 311A one by one, which look nice, and the user can easily take out plural booklets BK from stacking tray 311A.

The above explanation concerns the operation for adjusting the stacking position of the booklets on stacking section 311, in which the booklet is moved in the width direction. Next, detailed is the operation for adjusting the stacking position of the booklets, in which the booklet is moved in a direction perpendicular to the width direction, (that is, the booklet is moved in a direction perpendicular to the side surface to which binder BD is attached).

In step S1, if the booklet is moved in the direction perpendicular to the width direction, so that the stacking positions of booklets BK on stacking section 311 can be controlled (“No” in step S1), a moving distance of stopper 311B (see FIG. 3) on stacking section 311 is calculated (step S7).

The moving distance to be calculated in step S7 is used so that when booklets BK bound with the binder are stacked on stacking tray 311A, the binders of the booklets do not interfere the binder of preceding booklet. Said moving distance is calculated, based on information for reversing a booklet or not, information for types of binders to be used for the binding process, information for the thickness of a recording sheet to be used for a booklet, and information for the number of sheets included in a single booklet.

After the moving distance of stopper 311B has been calculated in step S7, judging is conducted whether the binding process of a single booklet in binding section 307 has been completed or not (step S8). If said binding process has been completed (“Yes” in step S8), stopper 311B is controlled to move (step S9), based on the moving distance calculated in step S7. In addition, step S8 can be conducted after step S9 has been conducted.

Said booklet is then stricken against stopper 311B by the operations of stacking section 306 and relay-conveying belt 309 (if said booklet is to be reversed, the operation of reversing section 310 is also included), whereby said booklet is ejected onto stacking tray 311A (step S10). Until the job has been completed, stopper 311B is controlled to move for each booklet in the horizontal direction, based on the moving distance calculated in step S7, so that the booklet is ejected onto stacking tray 311A. During the operations in step S7 to step S11, stopper 311B represents a position adjusting section of the present invention.

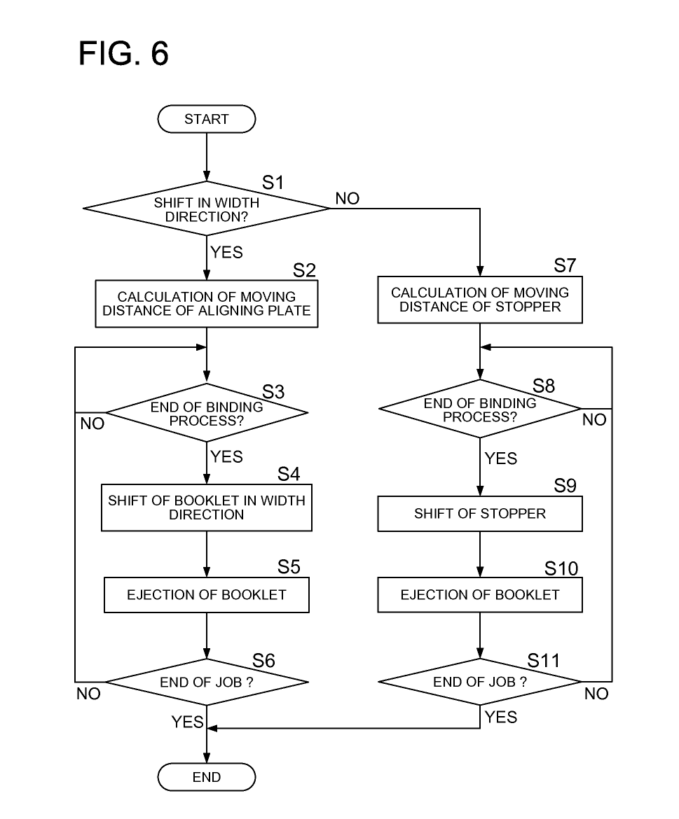

The stacking conditions of booklets on stacking tray 311A, based on steps S7 to S11 shown in FIG. 6, will now be detailed while referring to FIGS. 8 to 14. Each of FIGS. 8 to 14 shows a side view of stacking section 311, showing the condition of the booklets, wherein the stacking positions of the booklets have been adjusted.

Various embodiments will now be detailed, while referring to FIGS. 8 to 10, in which booklets are stacked on stacking tray 311A, but the front and reverse of the booklet is not reversed by reversing section 310 (see FIG. 3).

In an embodiment shown in FIG. 8, the booklets, each of which has been bound by ring-binder BD shown in FIG. 5a, are stacked on stacking tray 311A. In case that a booklet, bound with ring-binder BD, is to be stacked on stacking tray 311A, length R1 of ring-binder BD is calculated as a moving distance of stopper 311B in the horizontal direction (step S7 in FIG. 6).

To stack the booklet on stacking tray 311A, at each time when a booklet is ejected onto stacking tray 311A, stacking tray 311A is moved downward, its moving distance is the thickness of said booklet. Further, when the booklet is ejected onto stacking tray 311A, binder BD, attached to the booklet, strikes against stopper 311B, and stopper 311B is controlled to move for length R1 for each booklet, in the horizontal directions shown by arrow “d” in FIG. 8. As a result, the booklets are stacked on stacking tray 311A, while binders BD do not touch with each other, whereby the total height of the stacked booklets is controlled not to increase in the vertical direction in FIG. 8.

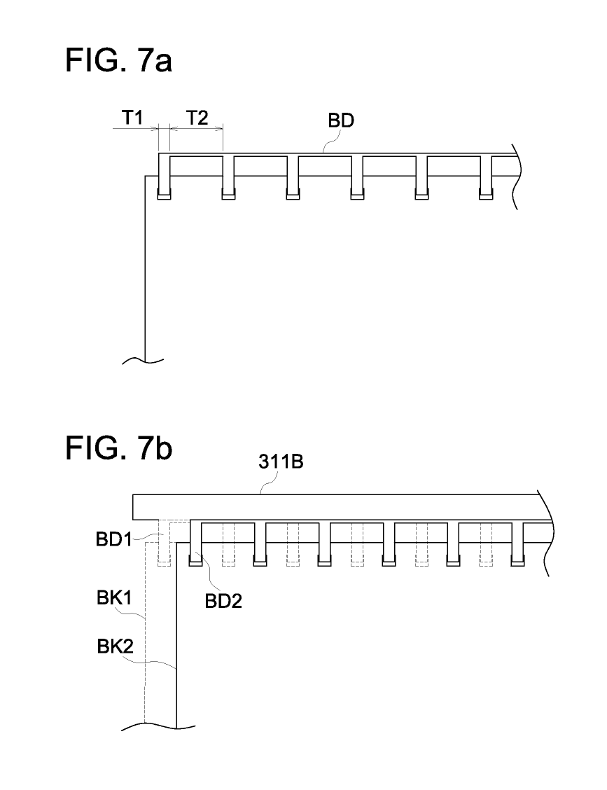

In an embodiment shown in FIG. 9, the booklets, each of which has been bound by a plate-binder shown in FIG. 5b, are stacked on stacking tray 311A. In this embodiment, length R2, which is from a bent top of binder BD to the end of first flat portion BD1, is calculated as a moving distance in the horizontal direction of stopper 311B (step S7 in FIG. 6). Said length R2 is calculated, based on information for the thickness of a recording sheet, and information for the number of recording sheets included in a single booklet.

In FIG. 9, stacking tray 311A is controlled to move downward, and stopper 311B is controlled to move for length R2 in the horizontal directions “d”, for each booklet, which is the same way as the case of the embodiment shown in FIG. 8. Accordingly, binders BD do not touch with each other, whereby the total height of the stacked booklets is controlled not to increase in the vertical direction.

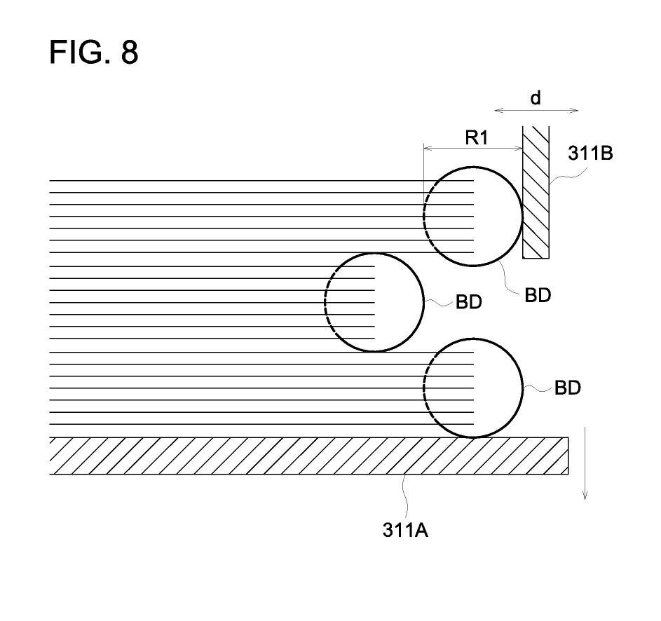

In an embodiment shown in FIG. 10, the booklets, each of which has been bound by a plate-binder shown in FIG. 5b, are stacked on stacking tray 311A. In the same way as the embodiment of FIG. 9, length R3, which is from a bent top of binder BD to the end of first flat portion BD1, is calculated as a moving distance in the horizontal direction of stopper 311B. However, when this embodiment is compared with the embodiment shown in FIG. 9, the number of recording sheets, included in a single booklet in FIG. 10, is greater than that of FIG. 9, so that R3 is smaller than R2.

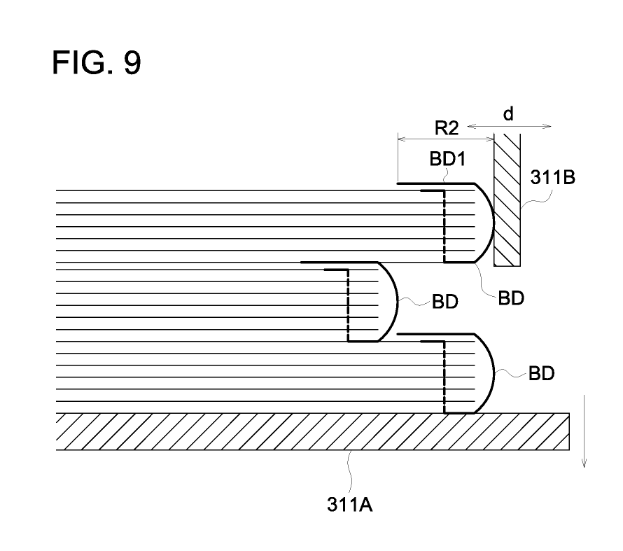

Next, other embodiments will now be detailed, while referring to FIGS. 11 to 14, in which booklets are stacked on stacking tray 311A, and the booklets are reversed by reversing section 310.

In an embodiment shown in FIG. 11, the booklets, each of which has been bound by the plate-binder shown in FIG. 5a, are stacked on stacking tray 311A. Stopper 311B is controlled to move for length P1 of ring-binder BD in the horizontal direction, so that the stacking position of each booklet can be adjusted.

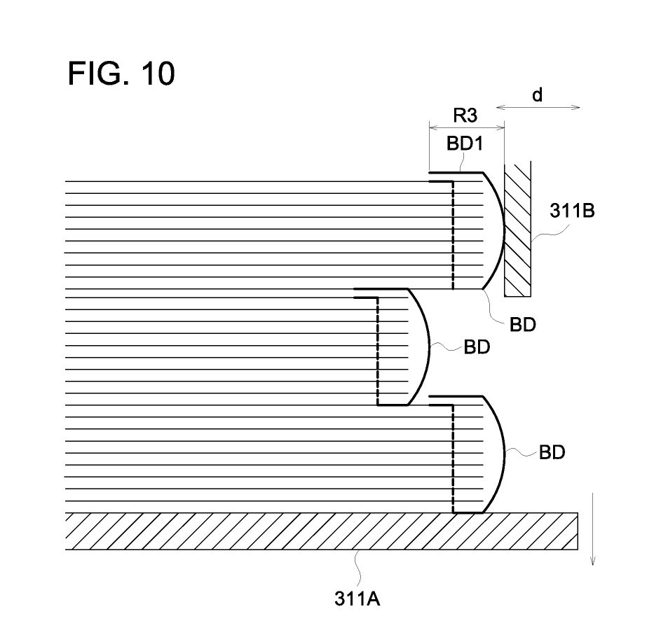

In an embodiment shown in FIG. 12, the booklets, each of which has been bound by a plate-binder shown in FIG. 5b, are stacked on stacking tray 311A. Stopper 311B is controlled to move for length P2, which is from a bent top of binder BD to the end of first flat portion BD1 of binder BD in the horizontal direction, so that the stacking position of each booklet is adjusted.

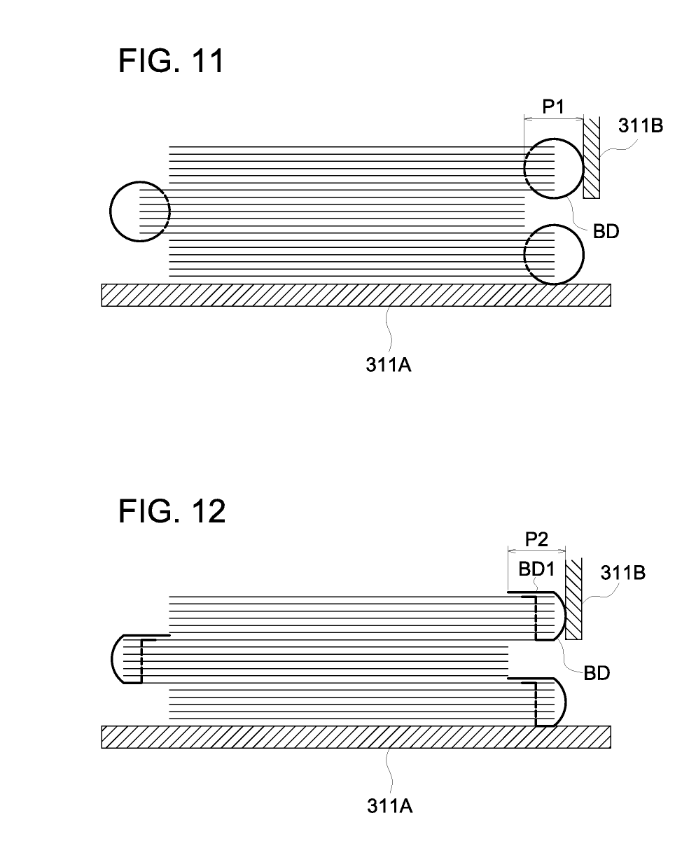

In an embodiment shown in FIG. 13, the booklets, each of which has been bound by a plate-binder shown in FIG. 5b, are stacked on stacking tray 311A. Stopper 311B is controlled to move for length P3, which is from a bent top of binder BD to a folded portion of second flat portion BD2 of binder BD in the horizontal direction, so that the stacking position of each booklet is adjusted. When the embodiment shown in FIG. 13 is compared with the embodiment shown in FIG. 12, length P3 in FIG. 3 is smaller than length P2 in FIG. 12. Accordingly, length Z1 in FIG. 13 can be effectively controlled shorter.

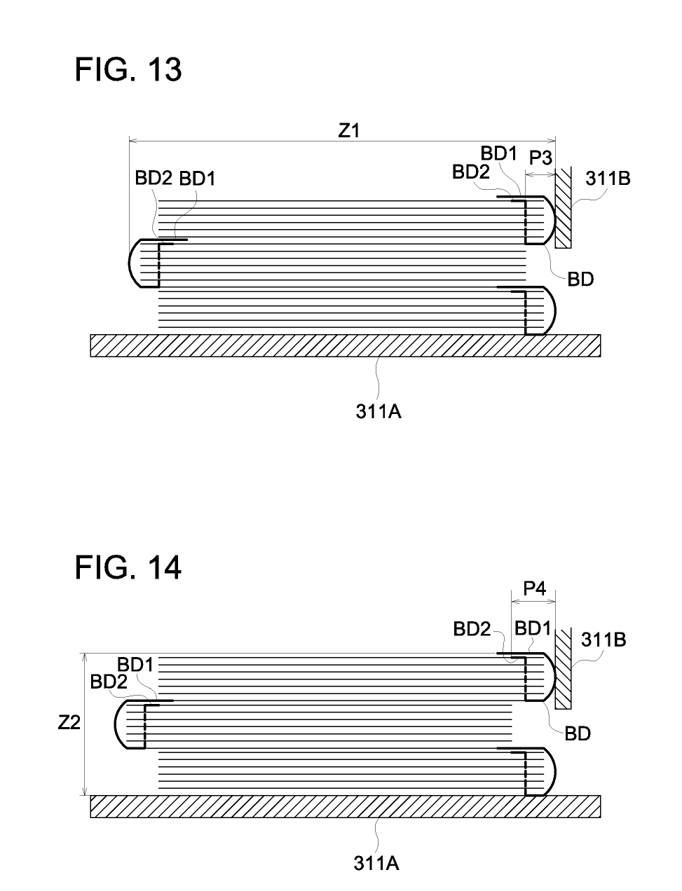

In an embodiment shown in FIG. 14, the booklets, each of which has been bound by a plate-binder shown in FIG. 5b, are stacked on stacking tray 311A. Stopper 311B is controlled to move for length P4, which is from a bent top of binder BD to the end of second flat portion BD2 of binder BD in the horizontal direction, so that the stacking position of each booklet can be adjusted. In FIG. 13, both first flat portion BD1 and second flat portion BD2 are placed between the stacked booklets, while in FIG. 14, only first flat portion BD1 is placed between the stacked booklets, whereby total height Z2 shown in FIG. 14 can be effectively controlled to be shorter.

As detailed while referring to FIGS. 8 to 14, since the booklets are moved in a direction perpendicular to the width of the booklet, the stacking positions of the booklets can be adjusted, and the binders attached to the booklets do not interfere with each other. Accordingly, increase of the total height of stacked booklets, due to binders being touching each other, does not occur. The number of the stacked booklets bound with the binder on stacking tray 311A can be sufficiently increased. Further, it is possible to stack the booklets on stacking tray 311A one by one, which look nice, and the user can easily take out plural booklets from stacking tray 311A.

The present invention has been detailed while referring to FIGS. 1 to 14. The present invention is not limited to the embodiments described above. The detailed structures and operations of the present embodiments can be appropriately changed within the scope of this invention, as long as it does not deviate from the contents of the present invention.

In the operations detailed while referring to FIG. 6, the stacking positions of the booklets, each bound with a binder, are controlled one by one, so that the binders do not interfere with each other, whereby the total height of the stacked booklets can be effectively controlled. Even if the binders come into slight contact with each other, but if the total height of the stacked booklets can be controlled to be less, which is included within the scope of the present invention.

What is claimed is:

1. A post finishing device for attaching a binder into punched holes of bundled sheets to bind the bundled sheets, and producing a booklet bound with the binder comprising:
a stacking section for stacking the booklet produced; and
a position adjusting section for adjusting a stacking position of the booklet on the stacking section, in such a way that when the booklet is stacked on the stacking section, the binder to bound the booklet does not come into contact with a binder of another booklet having been stacked on the stacking section.

2. The post finishing device of claim 1, wherein the position adjusting section moves the booklet bound with the binder, along a side surface, to which the binder is attached, of the booklet, and adjusts the stacking position of the booklet.

3. The post finishing device of claim 1, wherein the position adjusting section moves the booklet bound with the binder, in a direction perpendicular to a side surface, to which the binder is attached, of the booklet, and adjusts the stacking position of the booklet.

4. The post finishing device of claim 1, further comprising a reversing section for reversing front and reverse of the booklets one after another before the booklet is stacked on the stacking section, wherein the position of the binder of the one booklet stacked on the stacking position is opposite to the position of the binder of said another booklet.

5. An image forming system comprising:
an image forming apparatus for forming an image on a recording sheet; and
a post finishing device for producing a booklet bound with a binder, wherein the booklet is structured of the recording sheets carrying the images formed by the image forming apparatus, comprising:
a stacking section for stacking a booklet produced; and
a position adjusting section for adjusting a stacking position of the booklet on the stacking section, in such a way that when the booklet is to be stacked on the stacking section, the binder to bound the booklet does not come into contact with a binder of another booklet having been stacked on the stacking section.

6. The image forming system of claim 5, wherein the position adjusting section moves the booklet bound with the binder, along a side surface, to which the binder is attached, of the booklet, and adjusts the stacking position of the booklet.

7. The image forming system of claim 5, wherein the position adjusting section moves the booklet bound with the binder, in a direction perpendicular to a side surface, to which the binder is attached, of the booklet, and adjusts the stacking position of the booklet.

8. The image forming system of claim 5, further comprising a reversing section for reversing front and reverse of the booklets one after another before the booklet is stacked on the stacking section, wherein the position of the binder of the one booklet stacked on the stacking position is opposite to the position of the binder of said another booklet.
